(19) United States
(12) Patent Application Publication
(10) Pub. No.: US 2026/0356327 A1
(43) Pub. Date: Nov. 12, 2026

(54) ADAPTER FOR A WIPER SYSTEM

(71) Applicant: VALEO SYSTEMES D'ESSUYAGE, La Verriere (FR)

(72) Inventors: Vincent GAUCHER, La Verriere (FR); Laurent ANDRE-MASSE, La Verriere (FR); Olivier JOMARD, La Verriere (FR); Eric POTON, La Verriere (FR); Stephane HOUSSAT, La Verriere (FR)

(73) Assignee: VALEO SYSTEMES D'ESSUYAGE, La Verriere (FR)

(21) Appl. No.: 19/134,846

(22) PCT Filed: Dec. 11, 2023
(86) PCT No.: PCT/EP2023/085206

§ 371 Date: Jun. 2, 2025

(30) Foreign Application Priority Data
Dec. 14, 2022 (FR) FR2213404

(51) Int. Cl. B60S 1/40

(52) U.S. Cl. CPC B60S 1/40

(57) ABSTRACT

The present invention relates to an adapter for attaching a wiper blade to an arm of a wiper system, the adapter extending along a longitudinal direction, the adapter being configured to be rotatably mounted on a connector of the wiper blade. The adapter includes a locking device intended to block the adapter longitudinally with respect to the arm. The adapter also includes a front portion and a rear portion delimited from each other by a plane perpendicular to the longitudinal direction and passing through the locking device. The locking device includes at least one transverse wall arranged in the rear portion of the adapter. The adapter further includes a protrusion which extends between the transverse wall of the locking device and an element of the rear portion of the adapter.

### TECHNICAL FIELD

The present invention relates to the field of wiper systems for automotive vehicles. More particularly, the present invention relates to the field of adapters positioned between a wiper arm and a wiper of such wiper systems.

### BACKGROUND OF THE INVENTION

Automotive vehicles are commonly fitted with wiper systems for cleaning their glazed surfaces, and in particular their windshields. Such wiper systems comprise at least one wiper arm and a wiper driven by the wiper arm. The wiper arm is connected to an electric motor of the vehicle and the wiper comprises at least one wiper blade suitable for coming into contact with the glazed surface to be wiped. In order to be able to drive the wiper, an adapter is arranged between this wiper and the wiper arm. More particularly, the adapter is arranged between the wiper arm and a connector attached to the wiper. The adapter is then secured to the wiper arm and more particularly to a free end of the wiper arm by means of a locking device, it being possible to release such an engagement so that it allows the wiper to be changed when it has become worn.

To optimize the cleaning of the glazed surfaces of vehicles by means of wiper systems, said wiper systems and in particular the wipers must be pressed against the glazed surface to be cleaned. Consequently, means contributing to the pressing of the wipers against the surface are known, such as deflectors positioned on the wipers or formed on the adapter and causing the wipers to be pressed against the surface by the action of an air flow when the vehicle is in motion.

The operation of the wiper system, i.e. the driving of the wiper against the glazed surface by means of the wiper arm, can furthermore cause phenomena where the locking device of the adapter pivots relative to the body of the adapter as such. In other words, as the wiper rotates against the glazed surface, the locking device of the adapter can experience forces which exert a pull on the locking device. Such a pivoting of the locking device can then cause premature wear on the locking device of the adapter, which twists under the effect of the pivoting. Over time, it can break and cause the wiper to come off of the wiper arm while the wiper system is in operation.

### SUMMARY OF THE INVENTION

It will thus be understood that there is a need to address the above problem, which can cause incidents, both for the driver of the vehicle comprising the wiper system and for other road users who might be hit by the wiper released in this way.

The aim of the present invention is thus to provide an adapter of which the locking device can only pivot to a limited extent in order to reduce the risks of the wiper becoming separated from the wiper arm.

The main subject of the invention is an adapter for fixing a wiper to an arm of a wiper system, the adapter extending along a longitudinal direction, the adapter being configured to be mounted on a connector of the wiper with the ability to rotate about an axis of rotation transverse to the longitudinal direction, the adapter comprising a locking device intended to longitudinally immobilize the adapter in relation to the arm, the adapter comprising a front portion and a rear portion delimited from each other by a plane perpendicular to the longitudinal direction and passing through the locking device, the locking device comprising at least one transverse wall which extends transversely to the longitudinal axis and is disposed in the rear portion of the adapter, the locking device being mounted with the ability to pivot about a tilting axis parallel to the longitudinal direction, the adapter being characterized in that it comprises a protrusion which extends between the transverse wall of the locking device and an element of the rear portion of the adapter.

The wiper and the arm form part of a wiper system of a vehicle for at least partly cleaning a glazed surface of said vehicle. The wiper system thus comprises the arm which is made to rotate by an electric motor of the vehicle and provides the rotational movement of the wiper, to which it is rigidly connected via the adapter and the connector, against the glazed surface, so that the blade rubber held by the wiper clears said glazed surface of raindrops and/or solid debris deposited thereon.

The locking device also contributes to fixing the adapter to the arm, by immobilizing the adapter on said arm. By tilting, the locking device allows the adapter to be mounted on and/or removed from the arm. In the rest position, the locking device connects the adapter to the wiper arm at least in terms of translational movement.

The protrusion extending between the transverse wall of the locking device and the element of the rear portion of the adapter has a beneficial effect in that it forms a stop for limiting the pivoting of the locking device about an axis perpendicular to the longitudinal direction of the adapter and perpendicular, or perpendicular overall to the upper wall of the adapter, such that said locking device is not damaged. This limits the risks of the adapter and the wiper arm becoming separated.

According to one feature of the invention, the adapter comprises at least a lateral wall and an upper wall contributing to defining an internal volume of the adapter, the adapter comprising at least one guide channel which is intended for receiving the arm and extends at least partly in the internal volume of the adapter.

The guide channel in particular forms part of a recess for receiving the arm in the adapter, this recess extending longitudinally in the internal volume of the adapter. More particularly, the receiving recess extends in the front portion of the adapter and in the rear portion of the adapter, in particular together with the guide channel, the latter extending in the rear portion of the adapter.

According to one feature of the invention, the guide channel has a first longitudinal end via which the arm is intended to enter the channel and a second longitudinal end adjacent to the transverse wall of the locking device, the protrusion being formed between the transverse wall of the locking device and the second longitudinal end of the guide channel.

It will be understood that the second longitudinal end of the guide channel constitutes the element of the rear portion of the adapter.

According to one feature of the invention, the protrusion is integral with the transverse wall of the locking device.

According to one example of the invention, the locking device comprises a thrust member and an immobilizing member, the immobilizing member immobilizing the arm in the receiving recess of the adapter and extending at least partly facing the guide channel in the longitudinal direction of the adapter. Thus, in this example of the invention, the transverse wall of the locking device forms part of the immobilizing member.

According to one variant of the invention, the protrusion is integral with the element of the rear portion of the adapter.

According to the variant of the invention, the protrusion is integral with the second longitudinal end of the guide channel forming the element of the rear portion of the adapter.

According to one feature of the invention, the protrusion comprises at least one contact face which extends at least partly facing the transverse wall of the locking device or the element of the rear portion of the adapter, a longitudinal distance between the contact face and the transverse wall or the element of the rear portion ranging between 0.1 mm and 1 mm.

Such a longitudinal distance allows a maximum and controlled pivoting of the locking device relative to the adapter without this rotation causing damage to said locking device. The longitudinal distance is taken along a straight line parallel to the longitudinal direction of the adapter.

According to one feature of the invention, the guide channel comprises at least one retaining wall for retaining the arm in a vertical direction of the adapter, the protrusion extending in the longitudinal continuation of said retaining wall.

According to one feature of the invention, the retaining wall extends from the first longitudinal end to the second longitudinal end of the guide channel.

According to one feature of the invention, the shape of the protrusion matches the shape of the retaining wall of the guide channel in the longitudinal direction of the adapter.

According to one feature of the invention, the retaining wall of the guide channel comprises a transverse flank, a transverse edge of the protrusion extending in a common plane with the transverse flank.

According to one feature of the invention, the retaining wall comprises at least one bearing surface intended to be in contact with the arm positioned in the guide channel, the protrusion comprising a bearing face which extends in a common plane with the bearing surface of the retaining wall.

The invention also relates to a connection device for a wiper, comprising at least a connector and an adapter according to any one of the above features, the connector being mounted with the ability to rotate about the axis of rotation by means of a rotation device.

The invention also relates to a wiper comprising at least a connection device according to the above feature or an adapter according to any one of the above features.

The invention also provides protection for a wiper system comprising at least a wiper arm and a wiper according to the above feature, the arm comprising at least one rod accommodated in the guide channel of the adapter.

According to one feature of the invention, at least one end of the rod has a complementary shape to the guide channel of the adapter, the rod having a notch which cooperates with the locking device in order to longitudinally immobilize the position of the adapter on the rod.

### BRIEF DESCRIPTION OF DRAWINGS

Other features, details and advantages of the invention will become more clearly apparent on reading the description below and on studying several exemplary embodiments given by way of non-limiting indication with reference to the appended schematic drawings, in which:

FIG. 1 is a perspective view of a wiper system comprising at least an arm, a wiper and an adapter according to the invention;

FIG. 2 is a perspective view from above of the adapter shown in FIG. 1;

FIG. 3 is a perspective view from below of the adapter shown in FIG. 1;

FIG. 4 is a close-up view of a guide channel of the adapter in FIG. 1, capable of at least partly accommodating the arm of the wiper system; and

FIG. 5 is a close-up view of a protrusion of the adapter in FIG. 1.

The features, variants and various embodiments of the invention may be combined with one another, in various combinations, as long as they are not mutually incompatible or mutually exclusive. It will be possible, in particular, to conceive of variants of the invention that comprise only a selection of the features described below, in isolation from the other features described, if this selection of features is sufficient to confer a technical advantage and/or to distinguish the invention from the prior art.

In the figures, elements that are common to several figures have the same reference sign.

### DETAILED DESCRIPTION OF THE INVENTION

In the following detailed description, the terms “longitudinal”, “transverse” and “vertical” refer to the orientation of a wiper system and an adapter according to the invention. A longitudinal direction corresponds to a main direction of elongation of an adapter, this longitudinal direction being parallel to a longitudinal axis L of a trihedron L, V, T illustrated in the figures. A transverse direction is parallel to a transverse axis T of the coordinate system L, V, T and this transverse axis T is perpendicular to the longitudinal axis L. Finally, a vertical direction corresponds to a direction parallel to a vertical axis V of the coordinate system L, V, T, this vertical axis V being perpendicular to the longitudinal axis L and to the transverse axis T.

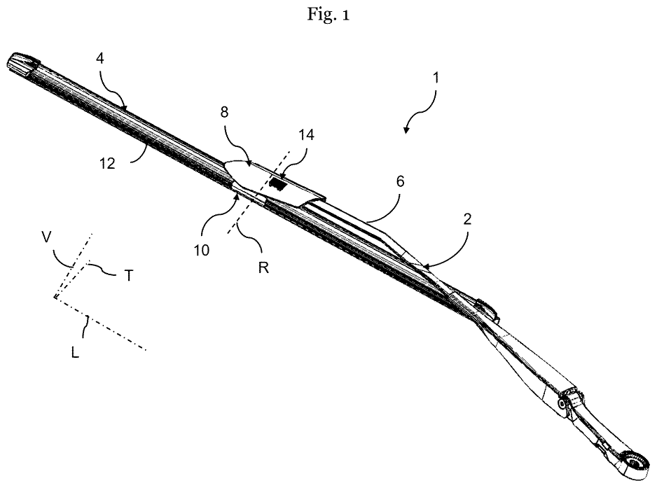

FIG. 1 illustrates a wiper system 1 configured for cleaning a glazed surface of a vehicle, for example a windshield, so as to improve a driver's view of the road in front of the vehicle, in rainy weather for example, or for the purpose of clearing said glazed surface of solid debris clinging thereto. The wiper system 1 extends mainly along the longitudinal direction L, and comprises at least a wiper arm 2 carrying a wiper 4 at one end, and being connected at another, opposite end with respect to the longitudinal direction L of the vehicle.

The arm 2 and the wiper 4 both extend mainly in the longitudinal direction L of the wiper system 1. More specifically, the arm 2 comprises a connection body which is intended for securing the arm 2 to the vehicle, and a rod 6 which extends from the connection body to one end of the arm 2. A “rod” is understood to mean a solid element which extends in the longitudinal direction L. In this case, the rod 6 has a rectangular cross section, as seen on a plane perpendicular to the longitudinal direction L. However, a rod with a discoid, triangular or other cross section would not be a departure from the scope of the invention.

In addition, the wiper 4 is in particular designed to be rotated by the arm 2 against the glazed surface of the vehicle, the arm 2 itself being rotated by a motor, not shown, for example an electric motor on board the vehicle.

In order to connect the wiper 4 to the end of the arm 2, said wiper 4 comprises a connection device 8 comprising at least one connector 10 which supports a wiper blade 12 of the wiper 4, and an adapter 14 which is mounted with the ability to rotate on the connector 10, the adapter 14 being able to cooperate with the end of the arm 2. It will be understood in particular that the wiper blade 12 of the wiper 4 is intended to be in contact with the glazed surface of the vehicle. Furthermore, the connector 10 is configured to directly or indirectly support the wiper blade 12.

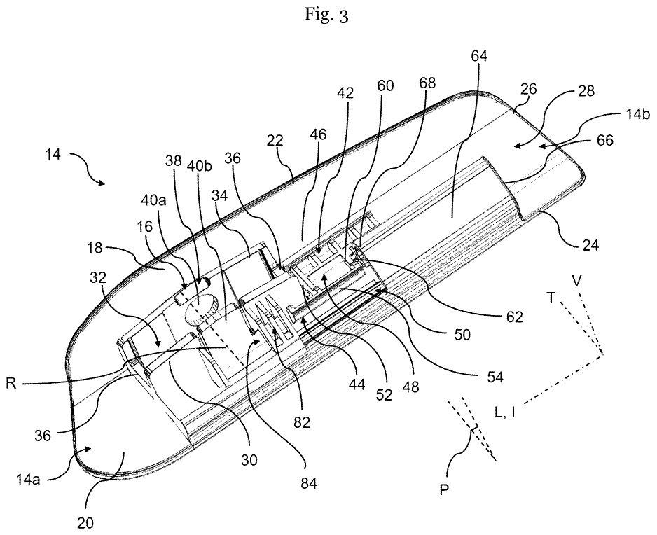

The adapter 14 and the connector 10 are rotated by means of a rotation device 16, partly shown in FIG. 3, this rotation taking place about an axis of rotation R substantially parallel to the transverse direction T. A more detailed description of the rotation device 16 will be provided later on in the description.

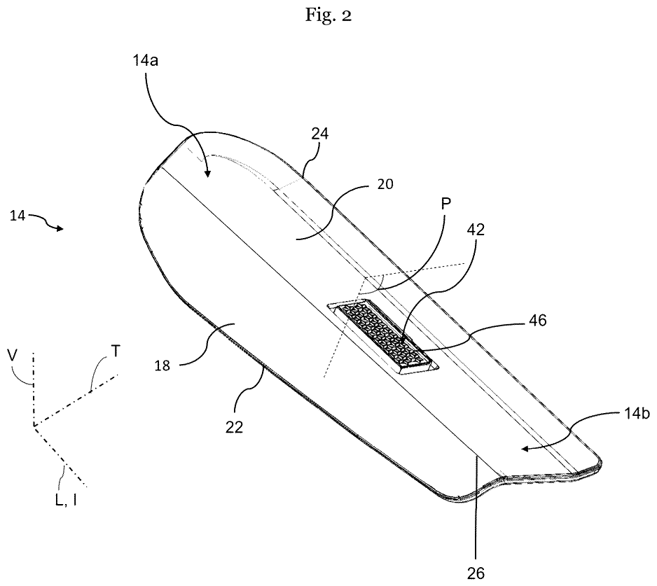

As shown more clearly in FIG. 2 and FIG. 3, the adapter 14 extends mainly in the longitudinal direction L. The adapter 1 comprises at least a lateral wall 18 and an upper wall 20, the lateral wall 18 and the upper wall 20 each having a free edge 22, 24 and an edge 26 common to the lateral wall 18 and the upper wall 20.

The lateral wall 18 extends mainly in a plane parallel to the longitudinal direction L and vertical direction V. In this case, the lateral wall 18 has a free edge 22 and a common edge 26 with the upper wall 20, the common edge 26 joining the lateral wall 18 and the upper wall 20 which each extend in separate planes.

The upper wall 20 also has a free edge 24, and extends between its free edge 24 and the common edge 26, having a curve shown in FIG. 1 and FIG. 2. It will be understood here that the upper wall 20 has a curved profile between the common edge 26 and its free edge 24, as viewed in the plane perpendicular to the longitudinal direction L, which is inscribed in a circle.

The adapter 14 according to the invention thus has a profile section in the shape of an L, as seen in a section perpendicular to the longitudinal direction L, i.e. which is inscribed in the transverse direction T and in the vertical direction V.

An internal volume 28, shown in FIG. 3, of the adapter 14 is defined, this internal volume 28 being at least partially delimited by the lateral wall 18 and the upper wall 20.

In addition, the adapter 14 comprises at least one internal wall 30 extending at least partly in the internal volume 28 of the adapter 14. More specifically, the internal wall 30 extends in a plane which is substantially parallel to the longitudinal direction L and vertical direction V, from the upper wall 20, in the internal volume 28. It will be understood that the internal wall 30 extends substantially parallel to the lateral wall 18.

According to the invention, the internal wall 30 contributes to at least partially delimiting a receiving area 32 intended to receive the connector. Thus, when the adapter 14 is mounted on the connector, the latter is at least partly accommodated in the receiving area 32.

Furthermore, and as shown more clearly in FIG. 3, the adapter 14 comprises several walls which contribute to delimiting the receiving area 32, including in particular the internal wall 30. More particularly, these walls extend to form a rectangle, the walls extending in a plane substantially perpendicular to the planes in which neighbouring walls extend. It will thus be understood that the adapter 14 comprises a longitudinal wall 34 extending parallel to the internal wall 30, and two connecting walls 36 extending perpendicularly to and between the longitudinal wall 34 and internal wall 30. It will thus be understood that when the adapter 14 is mounted on the connector, it is disposed at least partly between the internal wall 30 and the longitudinal wall 34, and between the connecting walls 36.

As mentioned above, the adapter 14 is mounted with the ability to rotate on the connector by means of a rotation device 38. This rotation device comprises multiple elements interacting with one another and positioned, on the one hand, on the connector and, on the other hand, on the adapter 14. In this case, only the elements of the rotation device that are supported by the adapter 14 are visible.

Thus, and as shown in FIG. 3, the adapter 14 comprises both a female element 40a on the longitudinal wall 34 which is configured to interact with a male element of the connector, which is not shown, and a male element which is intended to interact with a female element of the connector, which are not shown.

More specifically, the male elements take the form of a tab 40b supporting a strand, and the female elements 40a take the form of an orifice which receives the strand and in which the strand can rotate freely about the axis of rotation R. The tab 40b of the adapter 14 extends for example in a plane which coincides with the plane in which the internal wall 30 extends, and is delimited from said longitudinal wall 34 by at least one groove, and advantageously two grooves, extending in the vertical direction V. In this configuration, the tab 40b is resiliently deformable, while being movable about a direction of rotation parallel to the longitudinal direction L, so that the adapter 14 can be mounted on the connector.

According to one feature of the invention, the adapter 14 comprises a front portion 14a and a rear portion 14b delimited from each other by a plane P perpendicular to the longitudinal direction L and passing through a locking device 42.

The locking device 42 shown in FIG. 2 and FIG. 3 is intended to longitudinally secure the adapter 14 relative to the arm of the wiper system, the locking device 42 being mounted on the upper wall 20 with the ability to tilt about a tilting axis I parallel to the longitudinal direction of the adapter 14. The locking device 42 comprises at least one means 44 for limiting its pivoting about the tilting axis I, this means coming to bear against the internal wall 30 of the adapter 14 mentioned above.

More particularly, the locking device 42 comprises at least one thrust member 46, shown in FIG. 2, and one immobilizing member 48, shown in FIG. 3, the thrust member 46 lying in a profile of the upper wall 20 whereas the immobilizing member 48 extends at least partly into a receiving recess 50 which is intended for receiving the rod of the arm. A more detailed description of the receiving recess 50 will be provided after the locking device 42 has been described.

As illustrated in FIG. 2, the thrust member 46 extends in line with the upper wall 20, the thrust member 46 being flush with the upper wall 20. The thrust member 46 is also that member of the locking device 42 on which a user exerts a force in order to allow the locking device 42 to tilt about the tilting axis I.

The immobilizing member 48, for its part, is that member of the locking device 42 that is configured to be at least partly in contact with the rod of the arm 2, longitudinally securing the adapter 14 to the arm 2 and/or removing it therefrom. It will therefore be understood that the immobilizing member 48 interacts with the arm 2 in order to connect the adapter 14 to said arm 2.

As can be seen more clearly in FIG. 3, the immobilizing member 48 extends from the thrust member 46 to the receiving recess 50, the immobilizing member 48 comprising a bent portion 52 and a free end 54 which is positioned in the receiving recess 50 when the locking unit 42 is in a position of locking the adapter 14 on the arm 2.

It will be understood here that the bent portion 52 comprises a first part extending from the thrust member 46 in a first plane, and also a second part extending in a second plane which intersects the first plane toward the free end 54, the bent portion 52 comprising a connecting part which connects the first part to the second part. For example, the first plane is parallel to the longitudinal direction L and vertical direction V, the second plane extending parallel to the longitudinal direction L and transverse direction T.

The free end 54, for its part, takes the form of a shaft extending mainly in the longitudinal direction L.

The limiting means 44 is part of the immobilizing member 48. More particularly, the limiting means 44 and the immobilizing member 48 form a one-piece assembly, i.e. the limiting means 44 and the immobilizing member 48 cannot be separated from one another without destroying the limiting means 44 and/or the immobilizing member 48. In this case, the limiting means 44 continues the free end 54 longitudinally toward the receiving area 32. In other words, the free end 54 has a projection which continues the shaft forming the free end 54 longitudinally toward the receiving area 32, the projection acting as the limiting means 44.

The locking device 42 also comprises at least one transverse wall 60. The transverse wall 60 of the locking device 42 is understood to mean any wall that extends in a plane intersecting the longitudinal axis L of the adapter 14. More particularly, according to the example of the invention, the transverse wall 60 extends in the transverse direction T and in the vertical direction V and is part of the thrust member 46 or the immobilizing member 48 of the locking device 42.

According to the invention, the adapter 14 comprises a protrusion 62 which extends between the transverse wall 60 of the locking device 42 and an element of the rear portion 14b of the adapter 14. According to the example of the invention illustrated, the element of the rear portion 14b of the adapter 14 is a guide channel 64 which is part of the receiving recess 50, the guide channel 64 being intended for receiving the arm by extending at least partly in the internal volume 28 of the adapter 14.

More particularly, the guide channel 64 has a first longitudinal end 66 via which the arm is intended to enter the guide channel 64 and a second longitudinal end 68 adjacent to the transverse wall 60 of the locking device 14. It will thus be understood that the protrusion 62 is formed between the transverse wall 60 of the locking device 42 and the second longitudinal end 68 of the guide channel 64.

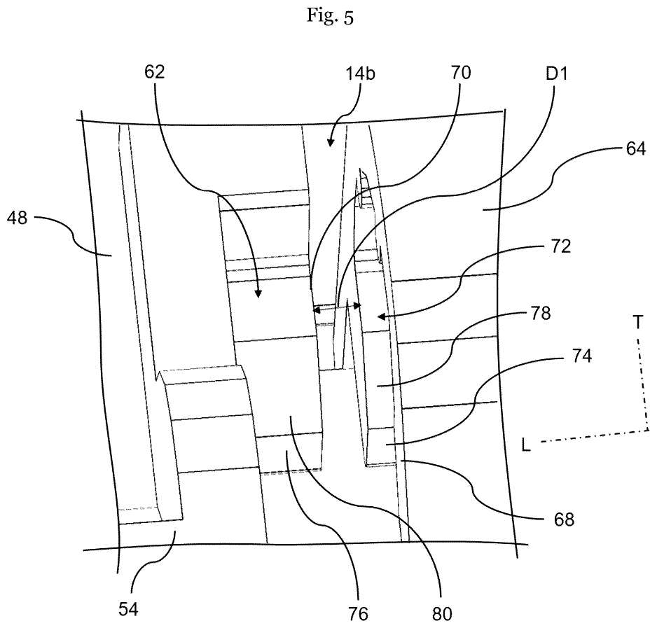

According to a first example of the invention, shown in FIG. 5, the protrusion 62 is integral (made of the same material) with the transverse wall 60 of the locking device 42. More particularly, the transverse wall 60 of the locking device 42 is positioned on the immobilizing member 48 of the latter, at the rear portion 14b of the adapter 14. The protrusion 62 then comprises at least one contact face 70 which extends at least partly facing the element of the rear portion 14b of the adapter 14, in this case the second longitudinal end 68 of the guide channel 64, with a longitudinal distance D1 between the contact face 70 and said second longitudinal end 68 ranging between 0.1 mm and 1 mm, advantageously being equal to 0.5 mm.

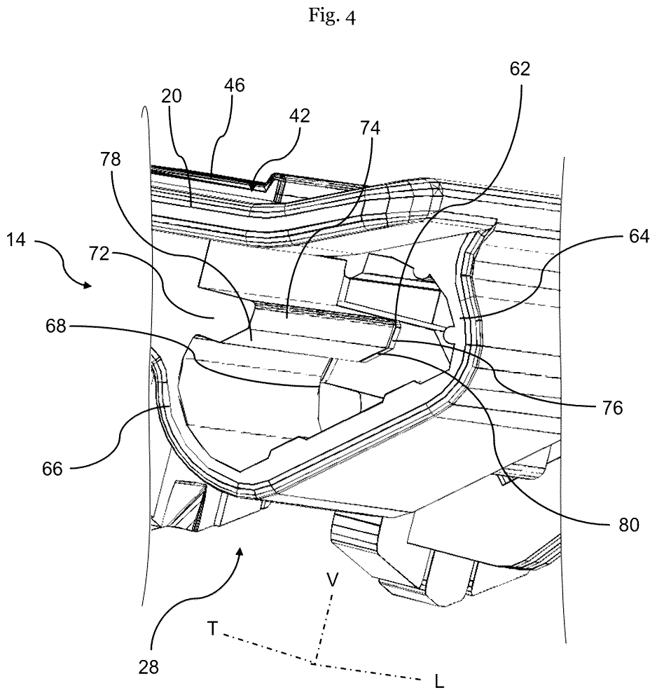

As FIG. 4 shows, the guide channel 64 comprises at least one retaining wall 72 for retaining the arm 2 in a vertical direction V of the adapter 14, said retaining wall 72 extending mainly in the transverse direction T and in the longitudinal direction L. The retaining wall 72 forms a tooth which has a free end, hereinafter referred to as transverse flank 74, intended to bear against the arm, such that the latter is retained in the guide channel 64 both in the transverse direction T and the vertical direction V.

The retaining wall 72 extends longitudinally in the guide channel 64 from the first longitudinal end 66 to the second longitudinal end 68. The protrusion 62, according to the example of the invention, thus extends in the longitudinal continuation of the retaining wall 72 of the guide channel 64.

The protrusion 62 furthermore has a shape which matches the shape of the retaining wall 72 of the guide channel 64 in the longitudinal direction L of the adapter 14. More specifically, a transverse flank 74 of the retaining wall 72 of the guide channel 64 and a transverse edge 76 of the protrusion 62 are defined, said transverse flank 74 and the transverse edge 76 extending in a common plane, in this case a vertical V and longitudinal L plane.

In addition, a bearing surface 78 of the retaining wall 72 that is intended to come into contact with the arm positioned in the guide channel 64 is defined, and a bearing face 80 of the protrusion 62 is defined, said bearing face 80 and the bearing surface 78 extending in a common plane, which in this case extends at least partly in the longitudinal direction.

Such a protrusion 62 has the beneficial effect of making it possible to form a stop for the locking device 42 when the wiper is mounted on the arm and when this wiper is subjected to a centrifugal force which tends to eject the arm, said wiper then being rotated and the pivoting of the locking device 42 relative to the rest of the adapter 14 being limited by the protrusion 62 which forms a stop between the immobilizing member 48 of the locking device 42 and the guide channel 64.

The adapter 14 also comprises at least one reinforcement 82, shown in FIG. 3, which extends between the internal wall 30 and the upper wall 20. The reinforcement 82 in particular comprises a wall extending mainly for example in a plane substantially perpendicular to the longitudinal direction L. The reinforcement 82 makes it possible to reinforce the structure of the adapter 14 and to optimize its rigidity. Furthermore, and as can be seen in FIG. 3, the reinforcement 82 comprises an opening 84 which contributes to at least partially delimiting the receiving recess 50. It will be understood that the opening 84 is intended to receive at least part of the rod of the arm. The reinforcement 82 extends in the front part of the adapter 14, in the direction away from the guide channel 64 which extends in the rear part 14b of the adapter 14, with respect to the plane P perpendicular to the longitudinal direction L and passing through a locking device 42.

As a result, and as shown more clearly in FIG. 3, the opening 84 of the reinforcement 82 and the guide channel 64 are aligned along a direction parallel to the longitudinal direction L, the rod of the arm therefore extending in the longitudinal direction L through the guide channel 64 and the opening 84 of the reinforcement 82.

According to the invention, the receiving recess 50 for receiving the rod of the arm is laterally offset from the receiving area 32 for receiving the connector, in the transverse direction T.

More specifically, the receiving area 32 is closer to the lateral wall 18 than the receiving recess 50. In other words, the receiving area 32 is positioned between the receiving recess 50 and the lateral wall 18.

Furthermore, according to one feature of the invention, at least one end of the rod has a complementary shape to the receiving recess 50 of the adapter 14, the rod having a notch, not shown, which cooperates with the locking device 42 in order to longitudinally immobilize the position of the adapter 14 on the rod of the arm. It will be understood that the free end 54 of the immobilizing member 48 is positioned in the notch of the rod, so that the rod is longitudinally immobilized in the receiving recess 50.

It will be understood that, to remove the wiper from the arm, the locking device 42 is tilted about its tilting axis I until the limiting means 44 abuts the internal wall 30. This tilting is, however, enough to release the adapter 14 from the arm while still limiting the risk of the locking device 42 breaking.

The present invention is not, however, limited to the means and configurations described and illustrated herein and it also extends to any equivalent means and configuration and to any technically feasible combination of such means.

What is claimed is:

1. An adapter for fixing a wiper to an arm of a wiper system, the adapter extending along a longitudinal direction, the adapter being configured to be mounted on a connector of the wiper with the ability to rotate about an axis of rotation transverse to the longitudinal direction, the adapter comprising a locking device intended to longitudinally immobilize the adapter in relation to the arm, a front portion and a rear portion delimited from each other by a plane perpendicular to the longitudinal direction and passing through the locking device, the locking device includes at least one transverse wall which extends transversely to the longitudinal axis and is disposed in the rear portion of the adapter, the locking device being mounted with the ability to pivot about a tilting axis parallel to the longitudinal direction, a protrusion which extends between the transverse wall of the locking device and an element of the rear portion of the adapter.

2. The adapter according to the claim 1, further comprising at least a lateral wall and an upper wall contributing to defining an internal volume of the adapter, the adapter comprising at least one guide channel which is intended for receiving the arm and extends at least partly in the internal volume of the adapter.

3. The adapter according to claim 2, wherein the guide channel has a first longitudinal end via which the arm is intended to enter the guide channel and a second longitudinal end adjacent to the transverse wall of the locking device, the protrusion being formed between the transverse wall of the locking device and the second longitudinal end of the guide channel.

4. The adapter according to claim 1, wherein the protrusion is integral with the transverse wall of the locking device.

5. The adapter according to claim 3, wherein the protrusion is integral with the element of the rear portion of the adapter.

6. The adapter according to claim 5, wherein the protrusion is integral with the second longitudinal end of the guide channel forming the element of the rear portion of the adapter.

7. The adapter according to claim 1, wherein the protrusion includes at least one contact face which extends at least partly facing the transverse wall of the locking device, a longitudinal distance between the contact face and the transverse wall between 0.1 mm and 1 mm.

8. The adapter according to claim 2, wherein the guide channel includes at least one retaining wall for retaining the arm in a vertical direction of the adapter, the protrusion extending in the longitudinal continuation of said the retaining wall.

9. The adapter according to claim 8, wherein the shape of the protrusion matches the shape of the retaining wall of the guide channel in the longitudinal direction of the adapter.

10. The adapter according to claim 8, wherein the retaining wall of the guide channel includes a transverse flank, a transverse edge of the protrusion extending in a common plane with the transverse flank.

11. A connection device for a wiper comprising at least a connector and an adapter, the connector being mounted with the ability to rotate about the axis of rotation by means of a rotation device and the adapter including a locking device intended to longitudinally immobilize the adapter in relation to the arm, a front portion and a rear portion delimited from each other by a plane perpendicular to the longitudinal direction and passing through the locking device, the locking device includes at least one transverse wall which extends transversely to the longitudinal axis and is disposed in the rear portion of the adapter, the locking device being mounted with the ability to pivot about a tilting axis parallel to the longitudinal direction, and a protrusion which extends between the transverse wall of the locking device and an element of the rear portion of the adapter.

12. A wiper comprising at least a connection device, the connection devices includes at least a connector and an adapter, the connector being mounted with the ability to rotate about the axis of rotation by means of a rotation device and the adapter including a locking device intended to longitudinally immobilize the adapter in relation to the arm, a front portion and a rear portion delimited from each other by a plane perpendicular to the longitudinal direction and passing through the locking device, the locking device includes at least one transverse wall which extends transversely to the longitudinal axis and is disposed in the rear portion of the adapter, the locking device being mounted with the ability to pivot about a tilting axis parallel to the longitudinal direction, and a protrusion which extends between the transverse wall of the locking device and an element of the rear portion of the adapter

13. (canceled)

14. The adapter according to claim 1, wherein the protrusion includes at least one contact face which extends at least partly facing the element of the rear portion of the adapter, a longitudinal distance between the contact face and the element of the rear portion between 0.1 mm and 1 mm.
